(19) United States
(12) Patent Application Publication
(10) Pub. No.: US 2014/0330648 A1
(43) Pub. Date: Nov. 6, 2014

(54) STORED VALUE CARD DISPLAY ADVERTISING SYSTEM AND METHOD

(71) Applicant: Gift Card Impressions, LLC, Kansas City, MO (US)

(72) Inventors: Brett R. Glass, Kansas City, MO (US); Karl Joseph Geisler, Olathe, KS (US); Kimberly Beth Hoag, Roeland Park, KS (US)

(73) Assignee: Gift Card Impressions, LLC, Kansas City, MO (US)

(21) Appl. No.: 13/946,749

(22) Filed: Jul. 19, 2013

Related U.S. Application Data
(60) Provisional application No. 61/818,795, filed on May 2, 2013.

(51) Int. Cl. G06Q 30/02

(52) U.S. Cl. CPC G06Q 30/0264
USPC 705/14.61

(57) ABSTRACT

A retail display advertising system includes a central management computing device in communication with a retailer computing device. The central management computing device selectively downloads advertising content associated with one or more stored value cards to a retailer computing device, and selectively download a specified schedule to each of the retailer computing devices. The retailer computing device, which is configured in a retail display structure that displays the stored value cards, manages output of each instance of advertising content according to the specified schedule.

### RELATED APPLICATIONS

This application takes priority to U.S. Provisional Patent Application Ser. No. 61/818,795, filed May 2, 2013, and entitled “Gift Card Display Advertising System and Method,” the contents of which is incorporated herein by reference in its entirety.

### FEDERALLY SPONSORED RESEARCH OR DEVELOPMENT

Not Applicable.

### COMPACT DISK APPENDIX

Not Applicable.

### FIELD OF INVENTION

The present invention generally relates to retail devices, and more particularly, to a stored value card display advertising system and method for stored value cards. Additionally, the present invention relates to a housing structure for housing and supporting a computing device that displays advertisements related to the displayed stored value cards.

### BACKGROUND

Transaction cards, or stored value cards, such as pre-paid phone services, general purpose, reloadable credit/debit cards, including open loop and closed loop prepaid cards, and the like, have become popular gifts. Stored value cards typically comprise a certain cash equivalent value that is encoded upon a magnetic strip applied to the surface of the card. This stored value may be determined by the vendor prior to packaging and display for sale or is selected at the point of sale by the purchaser and loaded by the cashier using a magnetic card reader/writer. Holders for stored value cards have been used both to simply store stored value cards and to provide a surface for decorative indicia and graphics, as well as personalized or preprinted text.

Stored value cards are typically displayed in a retail outlet in their non-activated (i.e., blank) form. Nevertheless, because these cards are relatively small in size, eye appeal may be somewhat difficult to attain for successfully marketing these stored value cards.

### SUMMARY

Embodiments of the stored value card kiosk system may provide a solution to conventional stored value card purchasing systems using a retail display system with a retail display unit (e.g., a kiosk) that includes a computing system with a display for displaying advertising content associated with the sale of stored value cards. The computing device has a display that may be mounted in close proximity to where retail stored value cards are displayed.

According to one aspect, a retail display advertising system includes a central management computing device in communication with a retailer computing device. The central management computing device selectively downloads advertising content associated with one or more stored value cards to a retailer computing device, and selectively download a specified schedule to each of the retailer computing devices. The retailer computing device, which is configured in a retail display structure that displays the stored value cards, manages output of each instance of advertising content according to the specified schedule.

According to another aspect, a retail display unit includes a retailer computing device and a retail display structure. The retailer computing device has a display and an audio generation device to play advertising content. The retail display structure supports and displays the display of the retailer computing device and one or more stored value cards for sale. The retailer computing device manages output of each instance of advertising content to at least one of the audio generation device or the display according to a specified schedule.

According to another aspect, a retail display advertising method includes selectively downloading advertising content associated with one or more stored value cards to a retailer computing device, selectively downloading a specified schedule to each of the retailer computing devices, and managing output of each instance of advertising content according to the specified schedule. The retailer computing device is configured in a retail display structure that displays the stored value cards.

### BRIEF DESCRIPTION OF THE DRAWINGS

FIG. 1 illustrates an example stored value card kiosk according to the teachings of the present disclosure.

FIG. 2A is a block diagram of a computing system that includes a stored value card advertising system.

FIG. 2B depicts an exemplary embodiment of a computing device according to one aspect of the stored value card advertising system.

FIG. 2C depicts an exemplary embodiment of a data source according to an aspect of the stored value card advertising system.

FIG. 3 is a block diagram of an example computing device that includes a stored value card advertising management application.

FIG. 4 is a flowchart depicting a process for generating advertising content according to an aspect of the stored value card advertising system.

FIGS. 5A through 5E illustrate another example stored value card kiosk according to the teachings of the present disclosure.

FIGS. 6A through 6D illustrate another example stored value card kiosk according to the teachings of the present disclosure.

FIGS. 7A through 7C illustrate an example retail display housing according to the teachings of the present disclosure.

FIGS. 8A through 8C illustrate an example retail display housing according to the teachings of the present disclosure

FIG. 9 illustrates another example retail display housing according to the teachings of the present disclosure.

### DETAILED DESCRIPTION

Although stored value cards have been become a commonly accepted gifting medium, their use has not been without limitation. For example, conventionally implemented stored value cards are typically small in size thus minimizing any visual appeal that may otherwise be obtained with physically larger retail products. That is, only a limited amount of information may be placed on these stored value cards due to the stored value card's relatively small size. As another example, conventionally implemented stored value cards are often produced and marketed in a manner that limits their overall consumer appeal. Although retailers may sell large numbers of stored value cards, these stored value cards are usually mass produced in only one or a few production runs each year, thus limiting seasonal or special event marketing that may otherwise be provided. Additionally, retailers typically generate planograms (i.e., diagrams indicating product layouts for a retail store) only once or twice per year, thus further limiting any benefit that would otherwise be provided by a system that continually updates advertising content related to stored value cards in close proximity to where the stored value cards are sold. Embodiments of the present disclosure provide a solution to this problem with a stored value card kiosk that includes a computing system with a display for displaying advertising content associated with the sale of the stored value cards. The computing device has a display that may be mounted in close proximity to where retail stored value cards are displayed.

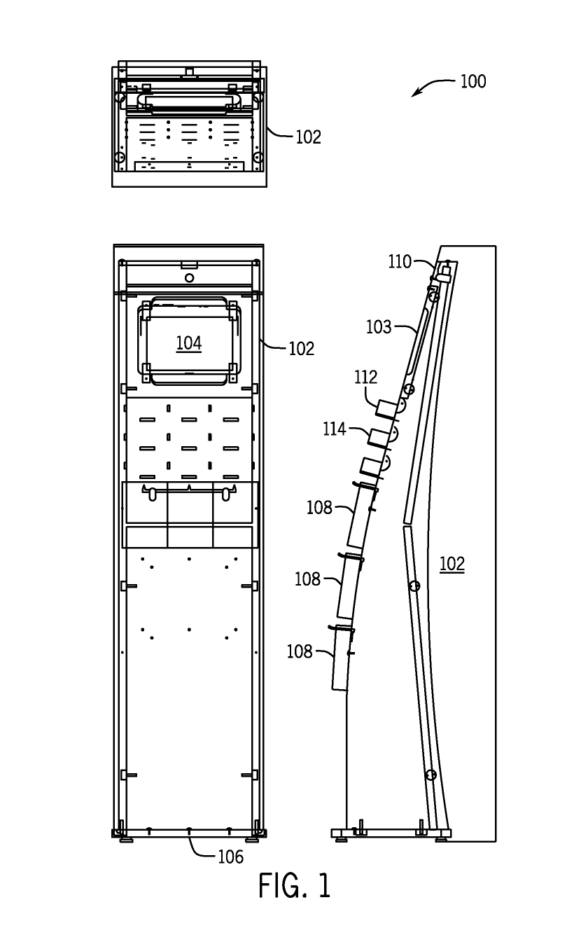

FIG. 1 illustrates an example stored value card kiosk 100 according to the teachings of the present disclosure. The stored value card kiosk 100 generally includes a housing structure, which in this particular embodiment, is a floorstand housing 102 that houses and supports a computing device 103 having a display 104. In other embodiments, the housing structure may be any type that supports the computing device 103 in a manner suitable for providing interaction with a user through its display 104, such as a pedestal, an adjustable support arm, or the like. Other types of housing structures will be described in detail below.

The floorstand housing 102 has a bottom end 106 for support from and/or mounting to a floor, and is dimensioned such that a user having a standard height may access the GUI in a relatively comfortable manner. In the particular embodiment shown, for example, the floorstand housing 102 has a height of 59 and ⅞ inches, a width of 15 inches, and a depth of 12 and ⅝ inches. Nevertheless, other embodiments of the floorstand housing 102 may have other dimensions without departing from the spirit or scope of the present disclosure. For example, other embodiments of the floorstand housing 102 may have a height greater or less than 59 and ⅞ inches, a width greater or less than 15 inches, and/or a depth of greater or less than 12 and ⅝ inches.

The floorstand housing 102 may be made of any suitable material, such as wood, plastic, composites, and/or metal, that supports the computing device 103 and display 104 in a structurally sound manner. The floorstand housing 102 may also include one or more pockets 108 for housing various ancillary items, such as non-activated stored value cards and/or paraphernalia associated with stored value cards. Each pocket 108 includes a cavity into which the ancillary items may be placed, and is formed of a generally rigid material, such as acrylic or sheet metal that is attached to the side of the housing 102. Nevertheless, other embodiments may include any type of housing structure for housing ancillary items associated with the advertisement of stored value cards. The particular embodiment shown merely describes one arrangement of the display 104 and pockets 108 on the housing 102 and that other arrangements may be provided without departing from the spirit and scope of the present invention. For example, the pockets 108, which hold the stored value cards, may be configured on the housing 102 at different locations on the housing and in some cases, may be mounted one other structures separate from the housing 102.

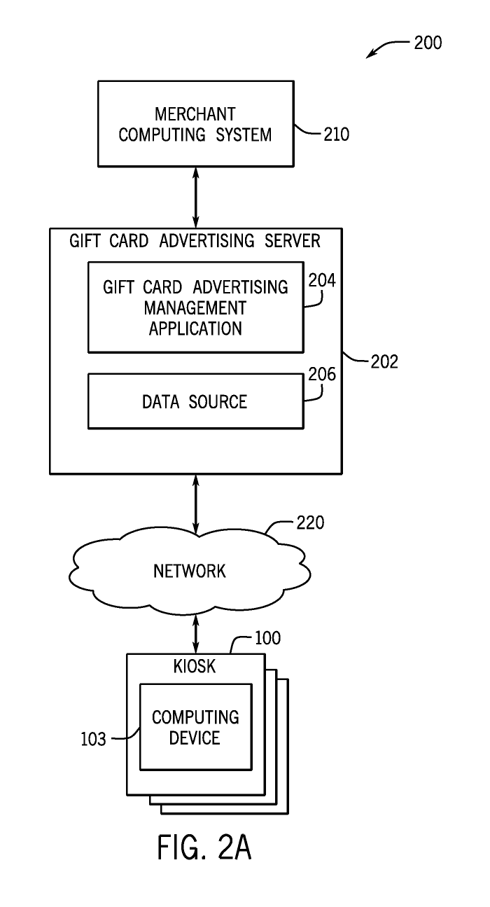

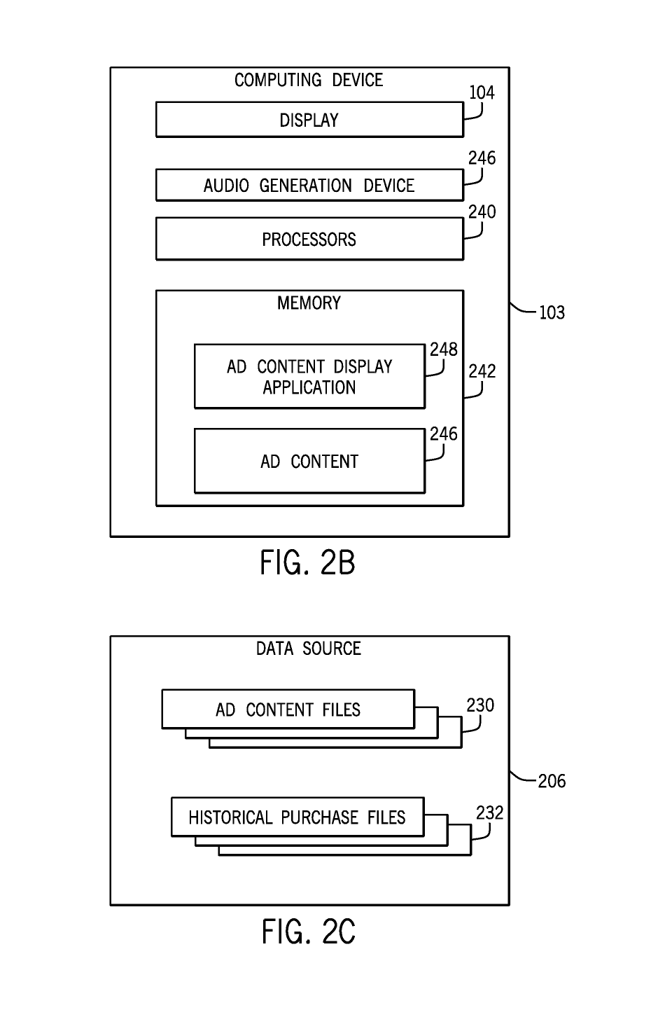

FIGS. 2A through 2C depict an example stored value card advertising system 200 according to aspects of the disclosure. The system 200 includes a stored value card advertising server 202 or other computing device or system that includes a stored value card advertising management application 204 and a data source 206. As will be described in detail below, the computing device 103 of one or more kiosks 100 receives stored value card advertising content from the stored value card advertising management application 202, and plays the received advertising content related to stored value cards displayed in the kiosk 100.

Advertising (e.g., marketing) content (e.g., advertisements, special offers, etc.) may be displayed on the display of the computing device 103 for view by the user. The advertising content may be pushed to the computing device 103 from the stored value card advertising server 202 and played under control of the stored value card advertising management application 204. For example, the administrator of the stored value card advertising server 202 may selectively push advertising content to be displayed based upon monetary payment of the merchant to be advertised. Thus, the marketing content may be pushed onto one, all, or only a selected subset of computing devices 104. The marketing content may be presented in any suitable form, such as a video segment, an animation, a text message, audio message, or any combination thereof. In some respects, the display of the computing device 103 may be considered to be a digital billboard in which advertising content is displayed to potential consumers in close proximity to where these consumers formulate decisions whether or not to purchase products (e.g., stored value cards) advertised by the display of the computing device 103.

The stored value cards may be any type of card that may be associated with a monetary amount to be redeemed for one or more products or services. Examples of such stored value cards include for example, pre-paid phone service cards, general purpose credit cards, debit cards, and the like.

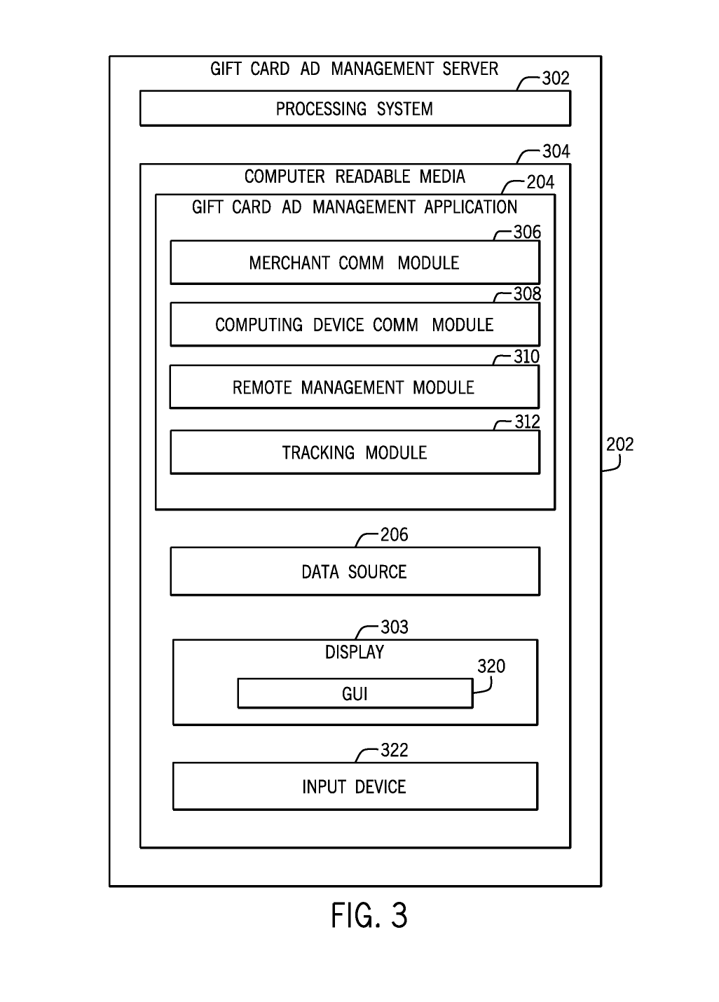

The server 202 includes a processing system 302 (FIG. 3) that execute the stored value card advertising management application 204 stored in volatile and/or non-volatile memory 304 (i.e., computer readable media) using the data source 206. Examples of a server 202 include one or more servers, personal computers, mobile computers and/or other mobile devices, and other computing devices. The server 202 may communicate via wireless and/or wireline communications.

The server 202 optionally may communicate with one or more merchant computing systems 210 that are associated with merchants that provide the stored value cards. The server 202 receives advertising content from the merchant computing system 210 that is subsequently pushed down to the computing devices 103 of the kiosks 100. The merchant computing system 210 has one or more processors and executable instructions stored in volatile and/or non-volatile memory for performing the actions and/or steps described herein.

The computing device 103 has one or more processors and volatile and/or non-volatile memory. In one embodiment, the computing device 103 a computing device 103 include one or more personal computers, mobile computers and/or other mobile devices, and other computing devices. In one embodiment, the computing device comprises a tablet computer. The computing device 103 may communicate via wireless and/or wireline communications.

The data source 206 stores advertising content files 230 including advertising messages in the form of text messages, audio messages, image messages, and/or video messages. The data source 206 may optionally store historical purchase files 232 including information associated with past purchases of stored value cards by each retail outlet having a kiosk 100.

Although the data source 206 is shown as being located on, at, or within the local server 202, it is contemplated that the data source 206 can be located remotely from the local server 202 in other aspects of the system 200, such as on, at, or within a database of a data management system or a database of another computing device or system having at least one processor and volatile and/or non-volatile memory.

The communication network 220 can be the Internet, an intranet, a circuit-switched telephone network, such as a public switched telephone network (PSTN), a cellular (i.e., wireless) telephone network, or another wired and/or wireless communication network. In one aspect, one or more of the server 202 and the computing devices 103 communicate with one another using any suitable protocol or messaging scheme. For example, the server 202 and computing devices 103 may communicate using a Hypertext Transfer Protocol (HTTP), extensible markup language (XML), extensible hypertext markup language (XHTML), or a Wireless Application Protocol (WAP) protocol. Other examples of communication protocols exist. Although the example of FIG. 2A shows the server 202 communicating with the computing devices 103 through a network, other embodiments contemplate the server 202 communicating directly with the computing devices 103 without the use of a separate and a distinct network. Additionally, other embodiments contemplate that the modules employed by the server 202 and the computing devices 103 are integrated in one computing system. Further, the servers 210 alternatively may communicate with the stored value card advertising server 202 via the network.

FIG. 2B depicts an example embodiment of a computing device 103 of the kiosk according to one aspect of the stored value card advertising system 200. The computing device 103 is a computing or processing device that includes one or more processors 240 and memory 242 and is to receive data and/or communications from, and/or transmit data and/or communications to, the server 202 via the communication network 220. The computing device 103 includes an audio generation device 246, and a display 104, such as a computer monitor, for displaying advertising content 248 stored in the memory 242 or advertising content 230 stored in the data source 206. The memory stores an advertising content display application 248 executed on the processors 240 to play advertising content on the audio generation device 246 and/or the display 104.

In one embodiment, the computing device 103 is a commercial off-the-shelf (COTS) computing device, such as a personal computer, a mobile computer, a tablet computer, a mobile device, and/or other computing device that is configured in or on the housing 102 using one or more mounting mechanisms, such as screws, bolts, hooks, zip ties, adhesives, track system, or other mechanism, such as one that maintains the computing device in or on the housing 102 using a tensioning mechanism. Such as COTS device includes a charging tether for providing power to the computing device, and/or a security or lasso tether to prevent its theft.

In another embodiment, the computing device 103 includes a custom design with the display 104, audio generation device 246, processors 240, and memory 242 individually integrated into the housing 102. For example, the display 104 and audio generation device 246 may be mounted on a surface of the housing 102 using a suitable attachment mechanism for providing advertising content to consumers. Example of such attachment mechanisms include, for example hinges and/or adhesives, such as weldment, hot glue, epoxy, and the like. Another example includes a housing 102 made of plastic that includes tabs integrally formed on the housing that hold the display 104 and audio generation device 246 in or on the housing 102 using a press-type fit. Yet another example includes tabs integrally formed on the housing 102 that are bent by the application of heat to secure the display 104, audio generation device 246, processors 240, and/or memory 242 to the housing 102.

In a particular embodiment, the computing device 103 is a tablet computer and the advertising content display application 248 is embodied as application software (i.e., an app) designed to be executed on the computing device 103. The operating software may be configured as a permissions-based format such that only the app is allowed to execute for administering the stored value card advertising system 100. That is, consumers may be inhibited from executing any other application on the computing device 103. Additionally, the app may be locked (i.e., inhibited from executing) in response to detection of a tampering event and/or due to malfunction of the system. The stored value card advertising server 102 may also include administrator privileges (e.g. super user mode) that can be accessed via a unique key combination (e.g., password access) for servicing, maintaining, or otherwise administering the operation of the computing device 103.

FIG. 3 is a block diagram depicting an example stored value card advertising management application 204 executing on the stored value card advertising server 202. According to one aspect, the stored value card advertising server 202 includes a processing system 302 that includes one or more processors or other processing devices. A processor is hardware. The processing system 302 executes the stored value card advertising management application 204 to selectively transmit advertising content to one, a subset, or all computing devices 103, and control the manner in which the transmitted advertising content is outputted (i.e., played) on the computing devices 103. Additionally, the application 204 may receive the advertising content from one or more merchant computing systems 210 associated with one or more merchants that sponsor the stored value cards displayed in the kiosk 100.

According to one aspect, the stored value card advertising server 202 includes a computer readable media 304 on which the stored value card advertising management application 204 and data source 206 are stored. The stored value card advertising management application 204 includes instructions or modules that are executable by the processing system 302 to perform the features of the application 204 described herein.

The computer readable media 304 may include volatile media, nonvolatile media, removable media, non-removable media, and/or another available media that can be accessed by the stored value card advertising server 202. By way of example and not limitation, computer readable media 304 comprises computer storage media and communication media. Computer storage media includes non-transient storage memory/media, volatile media, nonvolatile media, removable media, and/or non-removable media implemented in a method or technology for storage of information, such as computer/machine readable/executable instructions, data structures, program modules, and/or other data. Communication media may embody computer readable instructions, data structures, program modules, or other data and include an information delivery media or system.

A merchant communication module 306 facilitates the communication of advertising content and other information associated with the delivery and/or scheduling information associated with the advertising content to and from the merchant computing system 210. For example, the merchant communication module 306 may receive an instance of advertising content along with scheduling instructions for how long and at what times of the day that the advertising content is to be played on the computing device 103. For another example, the merchant communication module 306 may facilitate the transmission of offers for purchasing play time from the server 202 to one or more of the merchant computing systems 210.

A computing device communication module 308 facilitates the communication of advertising content and other information associated with the delivery and/or scheduling information associated with the advertising content to the computing devices 103 of the kiosks 100. For example, the computing device communication module 308 may communicate with the advertising content display application 248 to transmit advertising content that is played on the display 104 and/or audio generation device 246.

In one embodiment, the computing device communication module 308 may communicate with the advertising content display application 248 to transmit advertising content that is played on the display 104 and/or audio generation device 246 directly without being initially stored in the memory 242 of the computing device. In this particular embodiment, the stored value card advertising management server 204 may control at what time and with what frequency the advertising content is played on the computing system 103. In another embodiment, the computing device communication module 308 communicates with the advertising content display application 248 to transmit advertising content that is initially stored in the memory 242 of the computing device 103 along with instructions that may be used by the advertising content display application 248 for controlling at what time and with what frequency the advertising content is played on the computing system 103.

A remote management module 310 manages the play (i.e., output) of advertising content on the display 104 of the computing device 103 of the kiosks 100. The stored value card advertising management module 310 controls what advertising content is played, at what times the advertising content is played, and/or with what frequency the advertising content is played on each computing device 103. For example, the stored value card advertising management module 316 may schedule additional play time for advertising content associated with recreational merchants by a kiosk 100 located in a vacation region, while scheduling additional play time for advertising content associated with sporting paraphernalia by a kiosk 100 located near a sports stadium, or other sporting venue.

In one embodiment, the remote management module 310 generates a graphical user interface (GUI) 320 that displays various activities and provides for administrative control of one or more computing devices 103 of the kiosk 100 from the stored value card advertising server 202. For example, the GUI 320 may be generated in the form of a dashboard in which multiple characteristics of each of multiple computing devices 103 may be monitored and controlled. The GUI 320 is generated on the display 303 of the server 202 and various fields of the GUI 320 controlled via the input device 322 of the server 202.

The GUI 320 may display various characteristics of each computing device 103, such as sales data, location data obtained via a location detection device (e.g., global positioning system (GPS) device) of the computing device 103, device health, a history of tampering alerts, and any images/video obtained via the camera of the kiosk 100.

Additionally, the GUI 320 may receive user input via the input device 322 to control the operation of the computing device 103. For example, an administrator may, from the display 303 and input device 322 of the server 202, control the computing device 103 to inhibit or allow certain functionality, perform periodic maintenance on the computing device 103, and/or access one or more log files associated with the operation of the computing device 103.

In one embodiment, the administrator, via the GUI 320, may manage advertising content that is displayed on the GUI 248 of the remote computing device 103. For example, the administrator may set a first advertising message of a first merchant to be displayed on the GUI 248 at set intervals (e.g., every 10 minutes), and set a second advertising message of a second merchant to be displayed on the GUI 248 at other set intervals (e.g., every 30 minutes) based upon any previously made financial agreements between the merchants and the administrator of the server 202.

The advertising content may include any suitable type of content that may be displayed or otherwise played on the computing system 103 of the kiosk 100, such as textual, audio, images, photographs, and/or video content. For example, the advertising content may include information, such as special offers associated with the stored value cards, generic advertisements to generate enhanced consumer awareness of the merchant sponsoring the stored value card, information about how the stored value card may be redeemed by the recipient, information about particular retail products that may be purchased using the stored value card, and the like.

The remote management module 310 also communicates with the computing device 103 of the kiosk 100 to manage various aspects of its operation. For example, the remote management module 310 may communicate with the computing device 103 to ensure its proper operation, and disable the computing device 103 from further operation if a failure or malfunction is detected. In one embodiment, the remote management module 310 may erase the memory of the computing device 103 if a tampering event is detected. Also, the remote management module 310 may provide for remote access to the computing device 103 from the stored value card advertising server 202. The remote management module 310 may also communicate with the computing device 103 to administer software updates to the computing device 103.

In one embodiment, the remote management module 310 may communicate with one or more sensors of the kiosk 100 for surveillance and/or tamper detection purposes. For example, the remote management module 310 may receive images and/or video information from a camera of the kiosk 100 by generating an image of the nearby consumers at periodic intervals (e.g., 5 second intervals). The computing device 103 stores the images for future reference in the event that a tampering event is detected at a later time. Alternatively, the computing device 103 transmits the images to a stored value card advertising server 202 for storage in the data source 206.

An auditing and tracking module 312 maintains a historical record of stored value cards purchased by the retailer in which the kiosk 100 is placed and stores this information in the historical purchase information files 232. The stored value card purchase history may be obtained from any point-of-sale (POS) terminal (e.g., cash register) used by the retailer store site in which the kiosk 100 is placed. For example, the auditing and tracking module 312 may communicate with the point-of-sale terminals of the retailer to obtain historical purchase information of the stored value cards displayed on the kiosk 100. For another example, the stored value card advertising server 202 transacts purchases of (i.e., activates) stored value cards using a graphical user interface (GUI) of the computing device 103 to receive user information, and a card reader coupled to the computing device 103 to receive stored value card information and personal account information (e.g., credit card account) of the user for processing payment for the stored value card.

The auditing and tracking module 312 periodically processes this information to generate reports associated with the purchase of stored value cards by the retailer. These reports may be compared with the played advertising content to assess the effectiveness of the advertising content that is played on the computing device 103. In one embodiment, the auditing and tracking module 312 modifies the advertising content along with the time of day and the playing frequency of the advertising content according to the historical purchase information included in the reports.

The auditing and tracking module 312 monitors transactions conducted through the use of the kiosk 100 by storing the transactions in the historical purchase information 232. For example, the auditing and tracking module 312 may periodically report (or report upon demand) usage information associated with the kiosk 100. This usage information may include, for example, which type of stored value cards are most often activated and a distribution of how much money is activated on these cards. Information such as this may be useful for distribution to merchants that offer stored value cards to solicit their further use of the stored value card kiosk 100.

It should be appreciated that the modules described herein are provided only as an example of a computing device that may execute the stored value card advertising management application 204 according to the teachings of the present invention, and that other computing devices may have the same modules, different modules, additional modules, or fewer modules than those described herein. For example, one or more modules as described in FIG. 3 may be combined into a single module. As another example, certain modules described herein may be encoded and executed on other computing devices, such as the computing device 103 used by the user. Further, one or more or all of the modules may be stored and executed by the stored value card advertising server 202 and data and instructions are transmitted to and from the stored value card advertising server 202 and the computing device 103 to execute their functions. As yet another example, the stored value card management application 204 may, or may not have a merchant communication module 306 based upon whether automated content scheduling by the merchants sponsoring the advertising content is needed or desired. Additionally, the stored value card management application 204 may, or may not have an auditing and tracking module 312 based upon whether tracking of historical purchase information associated with the stored value cards is needed or desired.

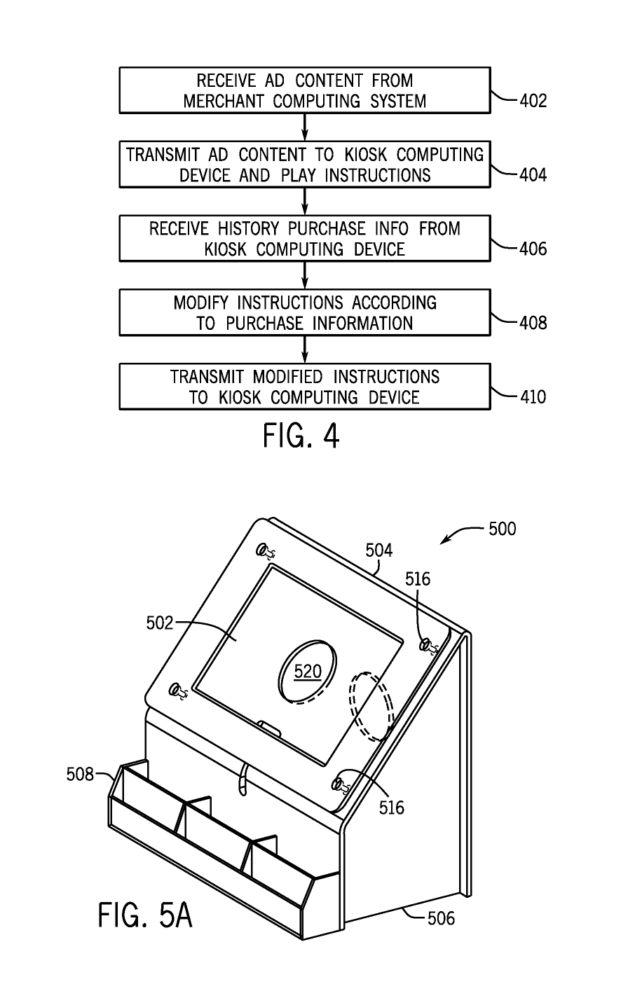

FIG. 4 illustrates an example process that may be performed by the stored value card advertising management application 204 according to the teachings of the present disclosure.

In step 402, advertising content is received from the merchant computing system 210. The advertising content may include any information, such as special offers associated with the stored value cards, generic advertisements to generate enhanced consumer awareness of the merchant sponsoring the stored value card, information about how the stored value card may be redeemed by the recipient, and/or information about particular retail products that may be purchased using the stored value card. Additionally, the advertising content may include advertising messages in the form of text messages, audio messages, image messages, and/or video messages.

In step 404, the advertising content and instructions associated with when the advertising content is to be played is transmitted to the computing device 103. In one embodiment, the advertising content is transmitted to the computing device 103 for immediate play without being initially stored in the memory 242 of the computing device. In this manner, the time of play is controlled primarily by the stored value card advertising management application 204. In another embodiment, the advertising content is transmitted to the computing device 103 along with instructions that may be used by the advertising content display application 248 for controlling at what time and with what frequency the advertising content is played on the computing system 103.

In step 406, historical purchase information is received from the computing device 103 of the kiosk 100 and subsequently processed to generate a report including the processed historical purchase information.

In step 408, the stored value card advertising management application 204 modifies the instructions for when and how the advertising content is to be played on the computing device 103. For example, if the report may indicate that sales of a particular stored value card has been relatively low since the last reporting period, the stored value card advertising management application 204 may increase the play frequency of advertising content associated with the particular stored value card to boost sales of that particular stored value card. In one embodiment, the report may be transmitted to the merchant computing system 210 for further analysis by the merchants that sponsor the stored value cards.

In step 410, the modified instructions are transmitted to the computing device 103 of the kiosk 100 such that the computing device 103 may commence playing the advertising content at a new schedule specified by the modified instructions.

The process described above continues throughout operation of the stored value card advertising management system 200. However, when use of the stored value card management system 200 is no longer needed or desired the process ends.

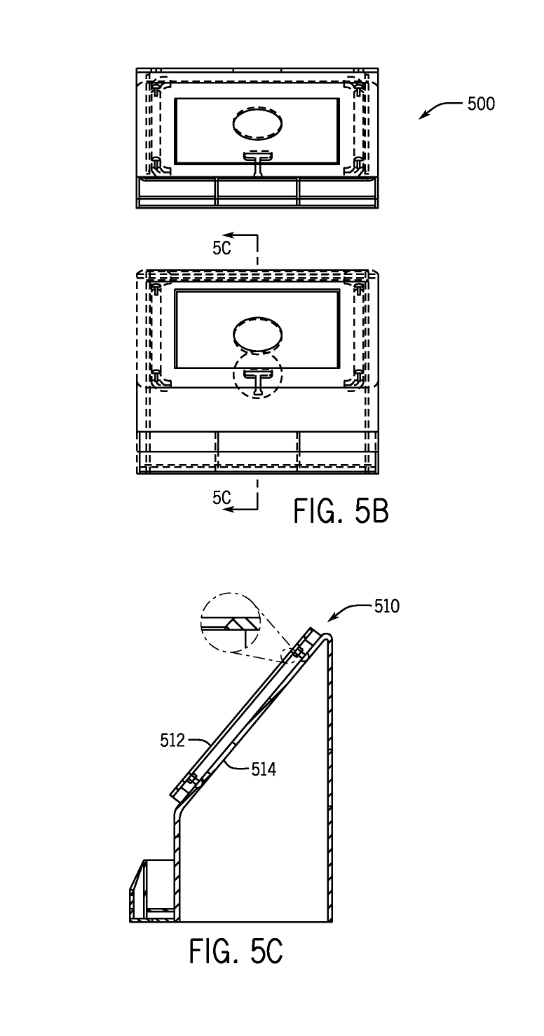

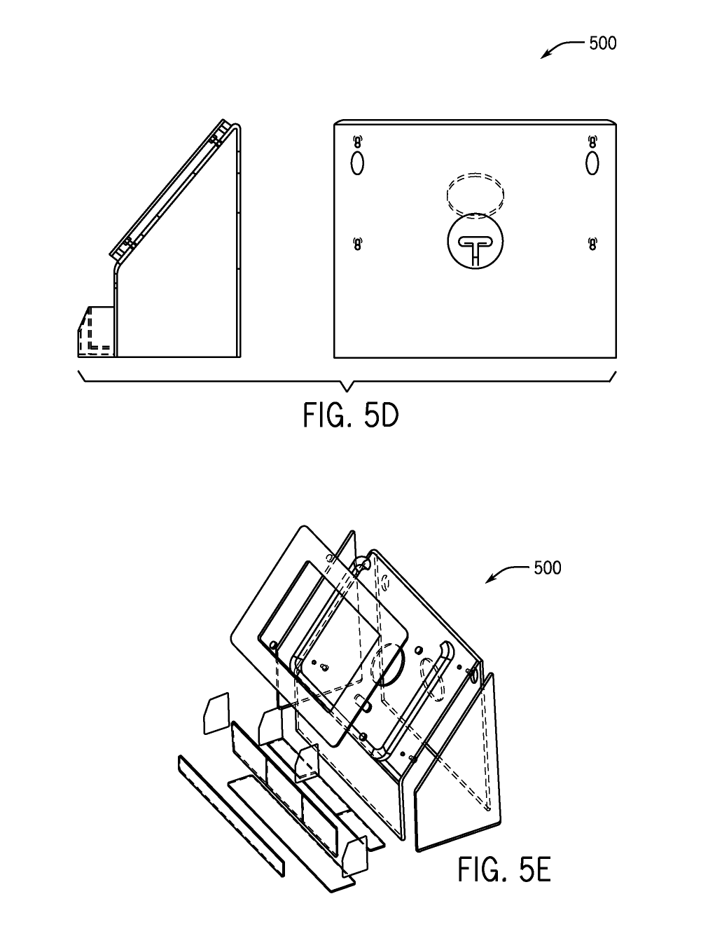

FIGS. 5A through 5E illustrate another example stored value card kiosk 500 according to the teachings of the present disclosure. The stored value card kiosk 500 includes a computing device 502 that functions similarly to the computing device 103 as described above with reference to FIG. 1. Additionally, the computing device 502 functions with the stored value card advertising system 200 as described above with reference to FIGS. 2 through 4 in a similar manner as the computing device 103 of FIG. 1. The stored value card kiosk 500, however, differs from the stored value card kiosk 100 of FIG. 1 in that the stored value card kiosk 500 includes a counter-top housing 504 that is to be mounted on a counter-top, such as a table, counter-top, or other suitable elevated support structure.

The counter-top housing 502 has a bottom end 506 for support from and/or mounting to a typical counter-top, and is dimensioned such that a user may access the GUI in a relatively comfortable manner. In the particular embodiment shown, for example, the counter-top housing 504 has a height of 10.406 inches, a width of 12.688 inches, and a depth of 5.375 inches. Nevertheless, other embodiments of the counter-top housing 504 may have other dimensions without departing from the spirit or scope of the present disclosure. For example, a wall-mounted housing, floorstand, or free standing housing may be used.

The counter-top housing 504 may be made of any suitable material, such as wood, composites, plastic, and/or metal that supports the computing device 502 in a structurally sound manner. The counter-top housing 102 may also include one or more pockets 508, shelves, or containers for housing various ancillary items, such as blank (non-activated) stored value cards and/or paraphernalia associated with stored value cards. In one embodiment, the pockets 508 are formed of an acrylic material. The pockets 508 formed of the acrylic material are transparent thus increasing eye appeal of any stored value cards and/or paraphernalia stored inside.

The counter-top housing 504 also includes a chassis 510 with a front plate 512 and a back plate 514 for secure confinement of the retailer computing device 103 using one or more tamper resistant screws 516 such that the computing device 103 is securely mounted to an outer surface of the counter-top housing 504. The front plate 512 includes a display hole to provide visibility of the display from in front of the retail display structure. Also, wherein the back plate 514 includes a hole 520 to provide access for electrical cords plugged into the retailer computing system.

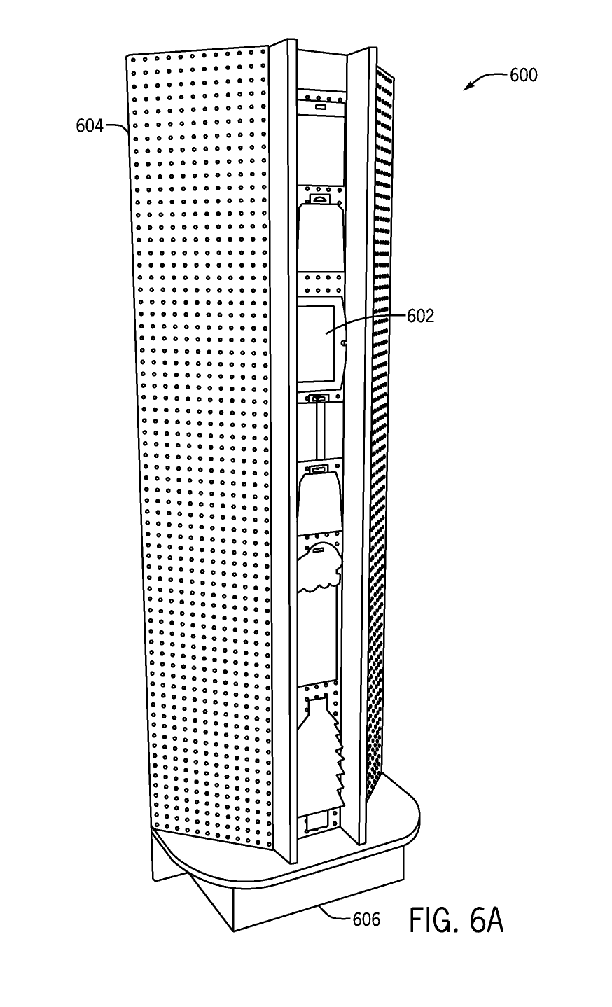

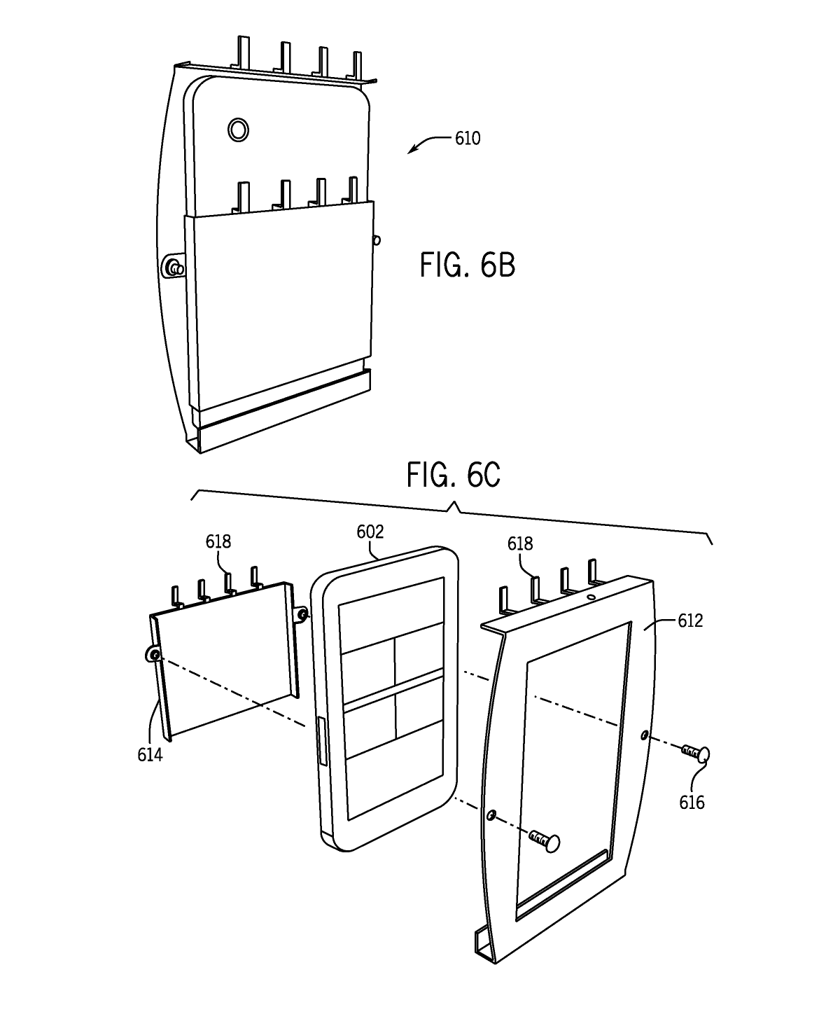

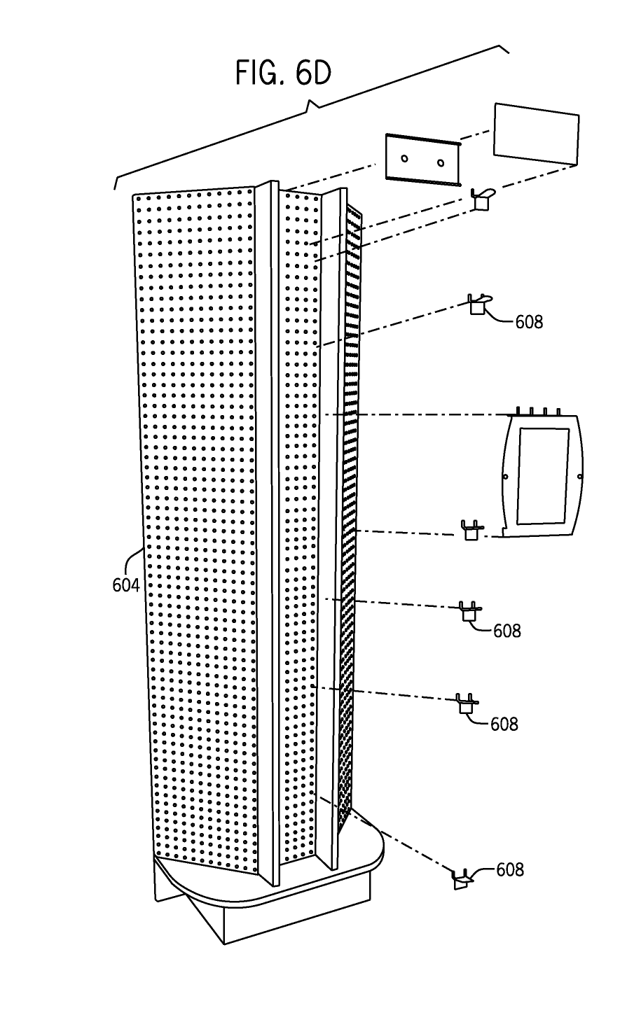

FIGS. 6A through 6D illustrate another example stored value card kiosk 600 according to the teachings of the present disclosure. The stored value card kiosk 600 includes a computing device 602 that functions similarly to the computing device 103 as described above with reference to FIG. 1. Additionally, the computing device 602 functions with the stored value card activation system 200 as described above with reference to FIGS. 2 through 4 in a similar manner as the computing device 103 of FIG. 1. The stored value card kiosk 600, however, differs from the stored value card kiosk 100 of FIG. 1 in that the stored value card kiosk 600 includes a retail display housing 604 that is to display other retail sale items along with the computing device 602.

The particular retail display housing 604 as shown has a floorstand-like structure with a bottom end 606 for support from a floor. In other embodiments, retail display housing 604 may be dimensioned for support from any suitable surface, such as, for example, a counter-top, a floor, a shelf, or a wall. The retail display housing 604 may be made of any suitable material, such as wood, plastic, composites, and/or metal, that supports the computing device 602 in a structurally sound manner. The retail display housing 604 may also include multiple regularly spaced holes that are designed to accept hooks 608 for hanging other retail sale items, such as stationary, postcards, or other gifting paraphernalia.

The retail display housing 604 includes a chassis 610 for securing the computing device 602 to the retail display housing 604. The chassis 610 generally includes a front plate 612 and a back plate 614 that securely confine the computing device 602 therebetween using tamper resistant screws 616. The front plate 612 and back plate 614 include hooks 618 that, when inserted into holes of the retail display housing 604, prevent removal of the chassis 610 from the retail display housing 604.

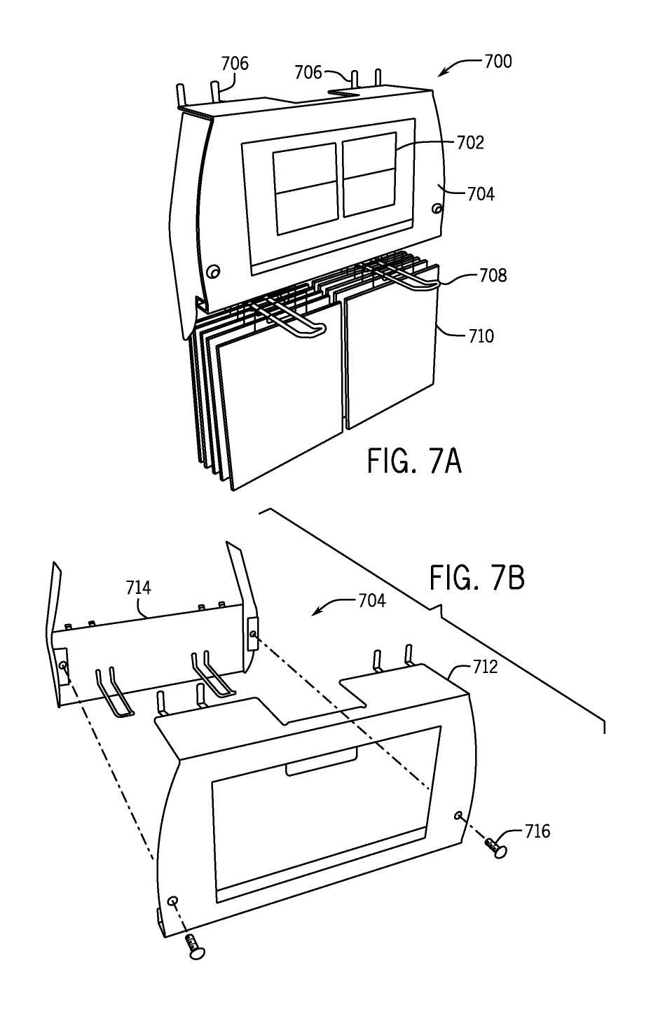

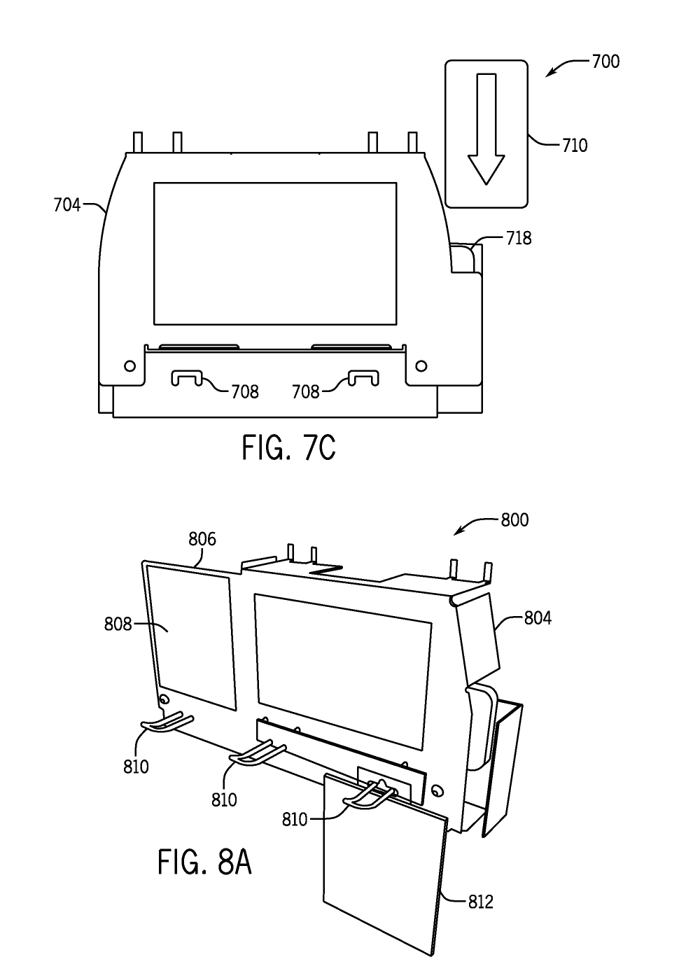

FIGS. 7A through 7C illustrate another example stored value card kiosk 700 according to the teachings of the present disclosure. The stored value card kiosk 700 houses a computing device 702 that functions similarly to the computing device 103 as described above with reference to FIG. 1. Additionally, the computing device 702 functions with the stored value card advertising system 200 as described above with reference to FIGS. 2 through 4 in a similar manner as the computing device 103 of FIG. 1. The stored value card kiosk 700, however, includes a chassis 704 that differs from the chassis 2110 of FIG. 21B in that the chassis 704 supports the computing device 702 such that its display is oriented in a landscape mode as opposed to the computing device 2110 that has the display of its computing device 2102 oriented in a portrait mode.

The chassis 704 as shown has a third party display mounting structure with hooks 706 to be supported from holes in a third party display. The third party display may be any retail display structure that is configured to display retail items. Examples of such third party displays may include, for example, the retail display housing 2104 of FIGS. 21A through 21C having a peg-board like structure for placement of various retail items. In other embodiments, the chassis 704 may include any type of securement mechanism for mounting to any wall. The chassis 704 may be hung from any suitable wall structure. For example, the chassis 704 may be hung at an elevation that conforms to the Americans with Disabilities Act of 1990 (ADA) requirements.

The computing device 704 may be any type and size. In one example, the computing device 704 is a tablet computer having a 7.0 inch display size. A tablet computer having such a size may be well accommodated into certain stored value card display corner posts.

The chassis 704 may be made of any suitable material, such as wood, plastic, composites, and/or metal that supports the computing device 702 on a wall in a structurally sound manner. The retail display housing 702 also includes two pegs 708 for supporting and displaying stored value cards 710 in close proximity to the computing device 702. Nevertheless, any quantity of pegs 708 may be used.

The chassis 704 with a front plate 712 and a back plate 714 for secure confinement of the retailer computing device 702 using one or more tamper resistant screws 716 such that the computing device 703 is securely mounted to an outer surface of a wall on which the retail display housing 700 is hung. The front plate 712 includes a display hole to provide visibility of the display from in front of the retail display structure. Additionally, the tamper resistant screws 716 may be configured on the chassis 704 such that they may also extend through a wall on which the chassis 704 is hung to secure the chassis 704 to the wall.

The chassis 704 has a depth D that supports the computing device 702 at a specified distance in front of the wall on which it is mounted. In the particular embodiment shown, the chassis 704 has a depth of approximately 2.0 inches for supporting the computing device 702 in front of a wall on which it is mounted. Nevertheless, other embodiments of the chassis 704 may have any desired depth D without departing from the spirit or scope of the present disclosure. Embodiments that support the computing device 704 a specified depth in front of a wall may provide an advantage in that the computing device 702 may be maintained closer to customers for increased eye appeal. Additionally, the chassis 704 requires relatively little floor space at a retail location; that is, it may be configured on an existing display shelf or other structure in a retail location without the use of any additional support structure that consumes floor space.

In one embodiment, the chassis 704 provides a closed frame around the computing device 704 such that the top and the back of the computing device 704 is covered, thus restricting access to these portions of the computing device 704. Additionally, the chassis 704 is formed such that, when the computing device 704 is housed therein, only certain physical ports of the computing device 704 are accessible. That is, the front plate 712 and/or back plate 714 may include one or more tabs for concealing physical ports that are to be restricted from access when the computing device 704 is housed in the chassis 704. For example, the chassis 704 may include a tab or other physical feature that covers certain critical buttons of the computing device 702, such as its “home” button or power button, to prevent their actuation.

As best shown in FIG. 7C, a card reader 718 is configured on the chassis 704 for receiving identification information associated with a stored value card to be purchased by a user, and financial information associated with a financial account of the user, such as credit card information provided by the user. For example, FIG. 7C shows a stored value card 710 in the process of being swiped through the card reader 718. As shown, the chassis 704 has an overall width of 9.750 inches with a width of 10.915 inches for providing clearance for swiping the stored value card 710 and/or credit card of the user. Nevertheless, the chassis 704 may have any suitable dimensional constraints for providing sufficient clearance for its display and for swiping a stored value card and/or credit card of a user. In one particular example, the card reader 718 may be configured on the front surface of the chassis 704 such that additional clearance width is not necessary for swiping the stored value card and/or credit card of the user.

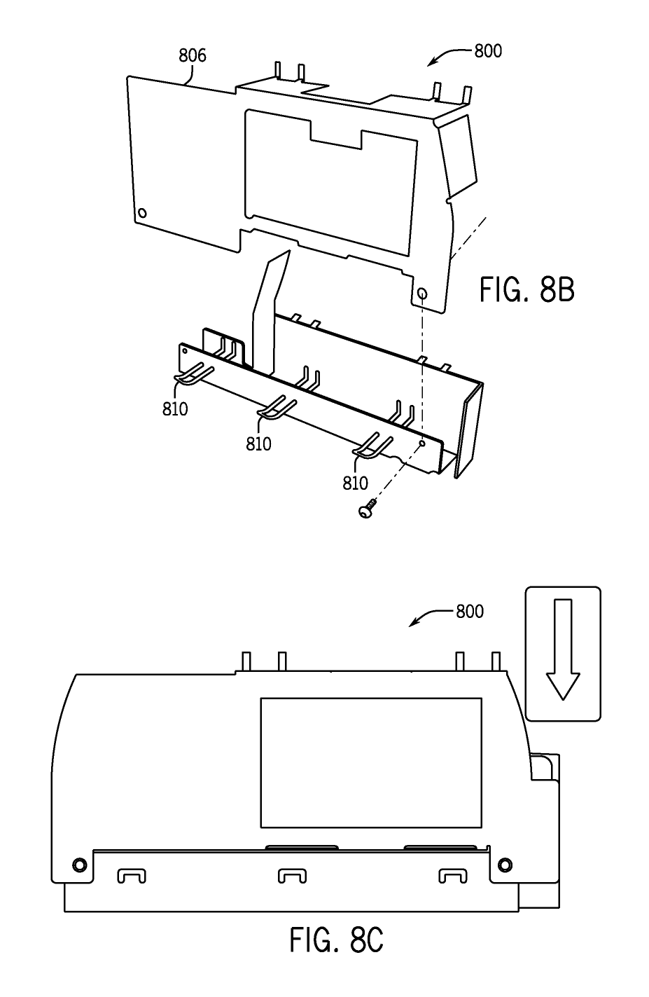

FIGS. 8A through 8C illustrate yet another example stored value card kiosk 800 according to the teachings of the present disclosure. The stored value card kiosk 800 includes a computing device 802 that functions similarly to the computing device 103 as described above with reference to FIG. 1. Additionally, the computing device 802 functions with the stored value card advertising system 200 as described above with reference to FIGS. 2 through 17 in a similar manner as the computing device 103 of FIG. 1. The stored value card kiosk 800 also includes a chassis 804 for housing the computing device 802 in a manner similar to the chassis 704 of the stored value card kiosk 700 of FIGS. 7A through 7C. The chassis 804 differs, however, in that it includes a front plate with a generally flat-shaped display region 806 for releasable mounting of a promotional graphic image 808 thereon. The chassis 804 of the kiosk 800 also differs from the chassis 700 of the kiosk 700 of FIGS. 7A through 7C in that three hooks 810 are provided for support of unactivated gift cards 812 on the kiosk 800.

Preferably, the graphic image 808 includes advertising content that promotes the sales of gift cards 812 displayed on the kiosk 800. For example, the graphic image 808 includes an animated image and overlaying text portraying some positive trait of at least one of the gift cards 812 displayed on the kiosk 800. The graphic image 808 as shown is formed on a generally rectangular-shaped piece of card stock that is mounted to the display region 806 using releasable adhesive or other releasable attachment means.

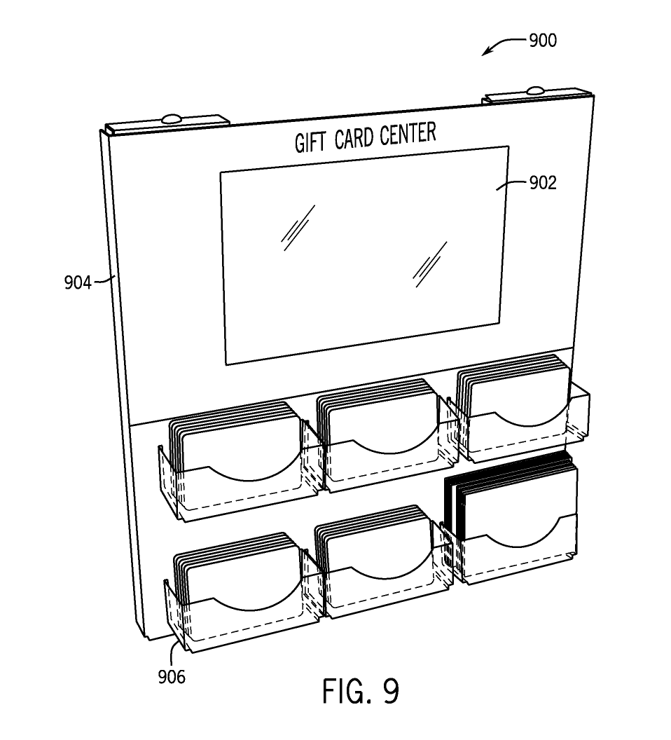

FIG. 9 illustrates yet another example stored value card kiosk 900 according to the teachings of the present disclosure. The stored value card kiosk 900 houses a computing device 902 that functions similarly to the computing device 602 as described above with reference to FIGS. 6A through 6D. Additionally, the computing device 902 functions with the stored value card advertising system 200 as described above with reference to FIGS. 2 through 4 in a similar manner as the computing device 103 of FIG. 1. The stored value card kiosk 900 differs however from the stored value card kiosk 600 of FIGS. 6A through 6D in that the stored value card kiosk 900 includes a generally rectangular-shaped housing 904 configured to be hung from a wall.

The particular stored value card kiosk 904 as shown has a wall-mount structure adapted for hanging from a wall using any suitable mounting mechanism. For example, the kiosk 904 includes holes in its back surface that are configured to accept anchors or screws that may be secured to a wall. Another example mounting mechanism includes one or more pegs that are shaped for insertion into a track mounting system or other system having a slot or depression that entraps the pegs. Other example of suitable mounting mechanisms may include adhesives, suction cups, magnets, zip ties, and the like.

The stored value card kiosk 900 includes one or more pockets 906 for holding stored value cards 908 is close proximity to the computing device 902. The pockets 906 are formed of a 0.060 inch thick sheet of transparent material, such as glycol-modified polyethylene terephthalate (PETG), although any suitable material may be used. Each pocket is approximately 2.0 inches deep for securely holding the stored value cards while allowing partial exposure so that they may be easily removed by users.

Those skilled in the art will appreciate that variations from the specific embodiments disclosed above are contemplated by the invention. The invention should not be restricted to the above embodiments, but should be measured by the following claims.

1-10. (canceled)

11. A retail display advertising method comprising:
selectively transmitting, using at least one processor executing instructions stored in at least one non-transitory computer-readable memory, advertising content, stored in a data source and associated with one or more stored value cards to a retailer computing device, the retailer computing device disposed in a retail display structure that displays the one or more stored value cards;
selectively transmitting, using the at least one processor, a specified schedule to each of the retailer computing devices;
managing, using the at least one processor, output of each instance of advertising content according to the specified schedule; and
performing, using the at least one processor, at least one of disabling the retailer computing device or erasing the memory of the retailer computing device when a tampering event is detected.

12. The retail display advertising method of claim 11, further comprising playing the advertising content using at least one of a display and an audio generation device of the retailer computing device.

13. The retail display method of claim 11, wherein the retailer computing device is one of a plurality of retailer computing devices.

14. The retail display method of claim 13, further comprising:
periodically receiving, by a central management computing device, historical purchase information from each of the retailer computing devices, the historical purchase information comprising retail sales information about one or more stored value cards associated with a particular merchant;
processing, by the central management computing device, the historical purchase information; and
generating a report including the processed historical purchase information.

15. The retail display method of claim 14, further comprising:
modifies the schedule at which the advertising content associated with the at least one merchant is played according to the report, the schedule comprising at least one of a type of the advertising content, a time of day at which the advertising content is played, and a frequency of playing the advertising content; and
transmitting the modified schedule to the retailer computing device.

16. A retail display advertising system comprising:
a central management computing device comprising memory storing computer executable instructions executable by at least one processor to:
selectively transmit advertising content associated with one or more stored value cards to a retailer computing device;
selectively transmit a specified schedule to each of the retailer computing devices;
wherein the retailer computing device is disposed in a retail display structure that displays the stored value cards;
wherein the retailer computing device manages output of each instance of advertising content according to the specified schedule; and
wherein the retailer computing device performs at least one of disabling the retailer computing device or erasing a memory of the retailer computing device when a tampering event is detected.

17. The retail display advertising system of claim 16, wherein the computing device comprises at least one of a display and an audio generation device to play the advertising content.

18. The retail display system of claim 16, wherein the retailer computing device comprises a plurality of retailer computing devices.

19. The retail display system of claim 18, wherein central management computing device:
periodically receives historical purchase information from each of the retailer computing devices, the historical purchase information comprising retail sales information about one or more stored value cards associated with a particular merchant;
processes the historical purchase information; and
generates a report including the processed historical purchase information.

20. The retail display system of claim 19, wherein the central management computing device modifies the schedule at which the advertising content associated with the at least one merchant is played according to the report, the schedule comprising at least one of a type of the advertising content, a time of day at which the advertising content is played, and a frequency of playing the advertising content, and transmits the modified schedule to the retailer computing device.

21. A retail display advertising system comprising:
a central management computing device comprising memory storing computer executable instructions executable by at least one processor to:
selectively transmit advertising content associated with one or more stored value cards to a retailer computing device;
periodically receive historical purchase information from each of the retailer computing devices, the historical purchase information comprising retail sales information about one or more stored value cards associated with a particular merchant, process the historical purchase information, and generate a report including the processed historical purchase information;
automatically modify the schedule at which the advertising content associated with the at least one merchant is played according to the report, the schedule comprising at least one of a type of the advertising content, a time of day at which the advertising content is played, and a frequency of playing the advertising content;
selectively and automatically transmit the modified schedule to each of the retailer computing devices;
wherein the retailer computing device is disposed in a retail display structure that displays the stored value cards; and
wherein the retailer computing device manages output of each instance of advertising content according to the modified schedule.
